(19) United States
(12) Patent Application Publication
(10) Pub. No.: US 2005/0192902 A1
(43) Pub. Date: Sep. 1, 2005

(54) Digital rights management using multiple independent parameters

(75) Inventor: Jim C. Williams, Yorba Linda, CA (US)

Correspondence Address: Brian M. Berliner;O'MELVENY & MYERS LLP, 400 South Hope Street, Los Angeles, CA, 90071-2899, US

(73) Assignee: MOTION PICTURE ASSOCIATION OF AMERICA

(21) Appl. No.: 11/003,864

(22) Filed: Dec. 3, 2004

Related U.S. Application Data
(60) Provisional application No. 60/527,462, filed on Dec. 5, 2003.

(51) Int. Cl. G06F 17/60

(52) U.S. Cl. 705/51

(57) ABSTRACT

A method and system for controlling distribution of digital content within a personal domain or localized personal domain that includes multiple receiving devices and makes use of independent parameters (e.g., “who,” “what” and “how many”) to determine a threat index. A rights management engine develops usage rights for devices in the domain, based on the threat index and a risk tolerance threshold for the digital content. The system may include a plurality of information-gathering tools for collecting the independent parameters for a personal domain of connected receiving devices.

### CROSS-REFERENCE TO RELATED APPLICATION

This application claims priority pursuant to 35 U.S.C. § 119(e) to U.S. Provisional Application No. 60/527,462, filed Dec. 5, 2003, which application is specifically incorporated herein, in its entirety, by reference.

### BACKGROUND OF THE INVENTION

1. Field of the Invention

The present invention relates to digital rights management, and more particularly, to systems and methods for independent verification of authorization status for a reception device.

2. Description of Related Art

Increasingly widespread consumer access to broadband networks has created new problems in the distribution of digital content. On the one hand, it is desirable to make digital content conveniently available for all intended uses to consumers. For example, it may be desirable to provide streaming content to a reception device that is broadband network-enabled. Such uses may become increasingly important as consumers continue to purchase entertainment devices that are network-enabled. It may further be desirable to permit consumers a controlled amount of redistribution of digital content, with or without payment of additional fees. For example, it may be desirable to provide a digital cable signal to a reception device such as a set-top box, and permit redistribution from there to different devices in a consumer's home, i.e., within a specific “localized personal domain.” Such arrangements may, for example, permit consumers to view purchased content in any desired room of the consumer's house. Various other redistribution schemes may also be desirable; for example, it may be desirable to permit redistribution from the cable reception device to any device owned by that same family regardless of whether it is in the consumer's primary house, vacation home, car or on his person, i.e., a specific “personal domain”.

Nevertheless, many network topologies do not provide for readily distinguishing between a nearby device and a remote device. From the point of view of a content provider, it can be difficult to discern whether content is being distributed to another device in the consumer's home, to a remote device in the person's car, or to a different family's home or other location. Thus, it may be possible for a consumer to redistribute content within a personal domain to remote users so as to contravene localization rights intended by the content provider or to redistribute content beyond the personal domain of the intended consumer.

It is desirable, therefore, to provide a system and method for distribution of digital content to a network-enabled device, that permits a greater degree of control over redistribution of content from the recipient device within a localized personal domain, personal domain and beyond. It is further desirable that the system be difficult to circumvent, while remaining convenient and easy to use for intended uses of the content at issue, including permissible redistribution.

### SUMMARY OF THE INVENTION

The present invention provides a system and method for content usage rights management using a plurality of independent parameters derived from characteristics of a personal domain. By itself, each of the independent criteria may provide relatively imprecise or ambiguous information about the compliance risk of transmitting content to a particular receiving device in the domain. But when used in combination, the independent criteria provide a reasonable approximation of whether a receiving device meets acceptable risk criteria and should be provided access to content. A system according to this invention may define a range of acceptable parameters for reception devices authorized to receive licensed content in a particular domain. Then, by comparing a threat index derived from the measured parameters to a risk-tolerance threshold determined by the content provider, a digital rights management system for content provided to the personal domain may determine whether to grant access to a requesting device, and if so, what usage rules should be placed on a given piece of content flowing to that device.

In the alternative, content may be delivered by conditional access systems, digital rights management systems or even in the clear, under certain known regulations that require certain compliance rules upon reception of such clear-to-air signal, with the expectation through license agreements or regulations that such received content will be managed in accordance with signaled usage rights and signaled or a priori risk-tolerance thresholds. Therefore, a rights management engine and centralized controller system may be included in the providers' source devices, or alternatively to a rights management systems and decentralized controller system may be embodied within one or more devices in the personal domain.

In an embodiment of the invention, the system gathers information about characteristics of the requesting devices, from which independent parameters for use in risk assessment may be developed. Using specialized assessment tools, the system may, for example, request information regarding identification of the user (“who”), geographic location of the requesting device (“where”), and how many networked systems will be able to receive the requested information (“how many.”) Information on these criteria may be sent from each assessment tool to a centralized controller system using a suitable secure method, for example, encryption.

The system may then generate a threat index based on the parameters. The index may make use of probabilistic estimation tools, including different weights assigned to different parameters. The rights management system may then use the secure threat index and defined risk-tolerance thresholds to determine content usage rules associated with particular content distributed to the personal domain. The usage rules should be implemented within the personal domain to prevent any receiving device that would exceed the risk-tolerance thresholds or not be in compliance with the rights management system from receiving or using the distributed content.

A few simple examples of the possible relationships between the who, where and how many parameters will help to illustrate. If content is signaled for usage by a single user or family at a time, there are different ways to establish that this is indeed the probable usage. One method would be to restrict the number of usage devices to a single device. This device could only be used by a single group of people, e.g., within viewing distance, at a time and therefore meets the criteria for allowed usage. A second method would be to use a personal account-based authorization system where a consumer associated a particular device with their account and a back-office function ensures that this account is associated with a single family. Only devices that were then associated with that account would be able to use the content in this example. A third method would be to ensure that all devices were located within a small area, e.g., a room or home, using, e.g., a Global Positioning System. All such devices may be allowed to use the content since they are in close proximity and likely owned or associated with a single user or family. Each of these three methods has different levels of success in achieving the initial goal of limiting usage to a single user or family at a time. They may also have different costs or different success rates in allowing usage in cases where it should be allowed and disallowing usage in cases where it should be disallowed.

In a real-world, cost effective situation, a system is unlikely to have perfect 100% accurate information about the who, where, how many, or other possible parameters. For example, perfect information about “who” may require a trusted inspector to knock on the door of the customer and verify their identity, or even watch them use the content. This extreme example is obviously not practical, desirable or acceptable in a consumer application. A combination of imperfect, but attainable parameters, along with a statistical model of how they together relate to the intended allowed or disallowed usage group, provides a reasonable approximation to the intended usage group.

Thus, for example, content may be distributed to multiple devices within a personal domain, so long as the signaled usage rights associated with that content allow such usage and a degree of certainty is established that the domain owner or the location of receiving devices within the domain are in accordance with those usage rights. Likewise, the number of devices permitted to receive content within the domain may depend on the degree of certainty about other criteria, such as the identity of the domain owner or its location. Usage rules may also be applied on an individual device level within the domain. For example, if a particular device in the domain has characteristics showing that it frequently switches domain membership, or is likely to be located in a different location than other devices in the domain, content may be restricted from that particular device.

A more complete understanding of the method and system for content rights management will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 is a flow chart showing exemplary steps for controlling distribution of digital content within a personal domain using a plurality of independent parameters.

FIG. 2 is a block diagram showing an exemplary system for controlling distribution of digital content within a personal domain, using a plurality of independent parameters.

### DETAILED DESCRIPTION OF THE PREFERRED EMBODIMENT

The present invention provides a method and system for content usage rights management in the context of a personal domain configured for redistribution of content from a receiving device that overcomes the limitations of the prior art. In the detailed description that follows, like element numerals are used to describe like elements appearing in one or more figures.

The method and system make use of a combination of available independent measured parameters to evaluate characteristics of networked devices and control redistribution over the in-home network. Any one of the parameters may provide imprecise or incomplete information about a particular networked device, but in combination, the criteria should provide an acceptable approximation for more precise control parameters.

Initial transmission of content to a networked receiving device may be secured as known in the art. In particular, the content provider should possess reliable information about who is receiving the content and where the content is being consumed. Such information may be obtained, for example, from subscription information and secure identification codes belonging to a subscriber. In the case of free-to-air broadcasts, the geographical range of the broadcast signal should be known with reasonable precision, and may be used to define a group of authorized users—those that are within the geographic range. Without sufficient control of the initial transmission, control of subsequent redistribution may be difficult or impossible. In addition, for the identified content consumer, the content provider should have defined rules governing use of the content, for example, how many consumption devices can be used or how many copies of the content are authorized for the receiving user.

Once content has been received by a networked-connected device, information concerning the receiving device and connected downstream devices may be used to control redistribution of the content over the network to that downstream device. The initial receiving device and authorized downstream receiving devices associated with the same user or family may be referred to as a user's “personal domain.” The devices of a user's “personal domain” that are located in close proximity to one another, e.g., in the same domicile, may be referred to as one of a user's “localized personal domains”. A combination of tools may be used to collect various different information regarding devices in a personal domain, and to analyze the information using provider-defined parameters as further described herein. Redistribution of content within or beyond the personal domain may then be managed according to rules controlled by the content provider, based on the provider's business model and the discovered characteristics of receiving devices or other network devices in the user's personal domain.

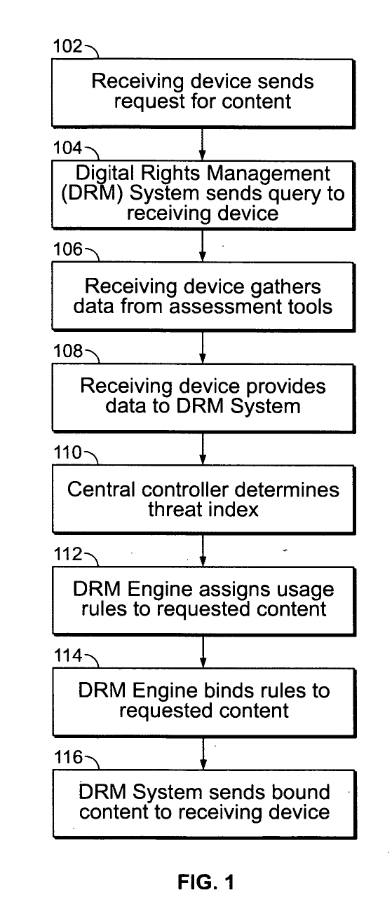

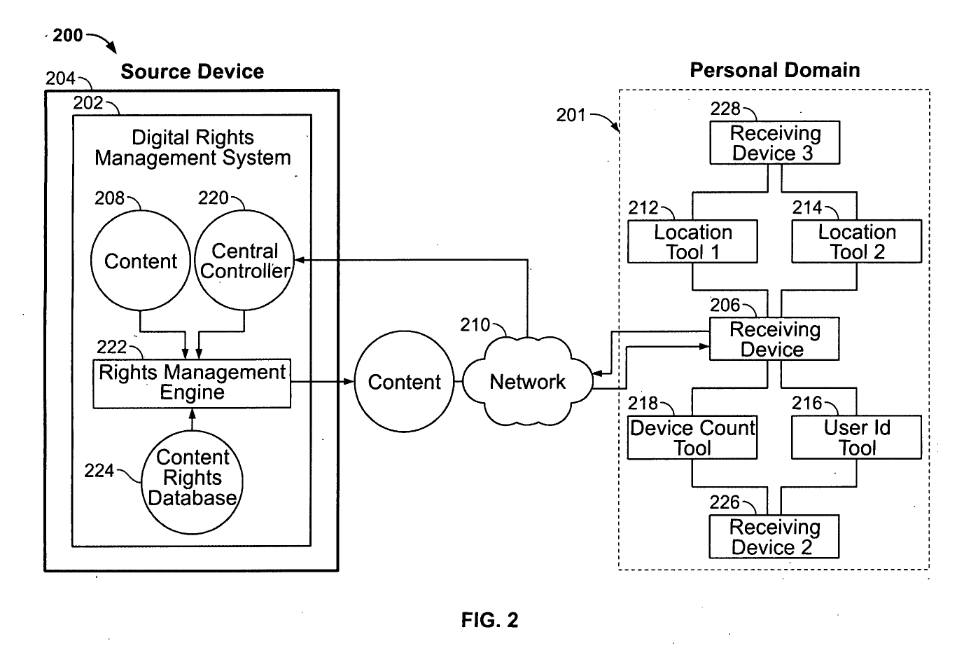

Both FIGS. 1 and 2 depict examples of the invention using a rights management engine and centralized controller system included in the provider's source device. Those skilled in the art will realize that the same methods and systems may be implemented by a rights management system and decentralized controller system embodied within one or more devices in the personal domain, using content usage rights signaled in a trustworthy manner (using cryptographic methods or enforceable compliance rules) from the source device.

FIG. 1 shows exemplary steps of a method for determining appropriate content usage rules for a requested piece of content, based on the control parameters of the requesting device's personal domain. At step 102, a Digital Rights Management (DRM) system receives a request for specific content from a requesting device. The request may be received over a network, for example, the Internet, or a satellite or cable network. The DRM system may comprise any suitable content-control system as known in the art, modified for operation as herein described. Alternatively, content may be broadcast using a Conditional Access system to control access to content in accordance with pre-established subscription rights. Also, content may be broadcast in-the-clear with embedded rights signaling information.

At step 104, the DRM system sends a query to the requesting device for information on the requesting device's personal domain. The requested information may comprise specific control parameters in the personal domain, including but not limited to the domain membership, the user identification, the geographic location of the requesting device, the relative location of the requesting device within the personal domain, and the number of consuming devices.

At step 106, the requesting device gathers information characterizing the personal domain, using parameter assessment tools located within its personal domain. The parameter assessment tools may include, for example, user identification tools, location determination tools capable of determining both geographic location within a given range and relative location of the devices within a personal domain, device counting tools for determining the number of active devices networked to the requester's personal domain, and domain management tools capable of determining the additions and withdrawals of devices from the active personal domain. Such tools may be implemented in any suitable combination of hardware or software within the personal domain, and may include tools as known in the art, for example, automatic number identification (ANI) or secure hardware keys, or tools such as may be developed in the future.

Although the invention is not concerned with or limited to specific information-gathering tools, some examples of possible tools, in addition to ANI, may serve to illustrate the nature of information that may be gathered and used for determination of content usage rules. For example, information concerning relative proximity of devices in the personal domain may be determined by “pinging” such devices and measuring response or transmission times. Information concerning the network in the personal domain may be determined by analyzing how the network handles different types of messages, or from message header information. Information concerning absolute geographic location of devices in the personal domain may be determined using a connected Global Positioning System (GPS) receiver, or by analyzing signals received by a connected broadcast radio or television receiver. Information concerning a number of connected receiving devices in the domain may be determined in various ways, including by maintaining a database of authorized receiving devices in the domain or counting responses from general information requests to all devices in the personal domain. In general, information gathered using such tools may comprise information concerning “who” the personal domain belongs to, e.g., the account holder or authorized user, “where” receiving devices are located, and “how many” receiving devices are in the personal domain.

Step 106 may be performed in response to a query from a content provider, or at other times determined by the requesting device. For example, the requesting device or any connected device may maintain a database of personal domain properties. This database may be updated upon occurrence of certain conditions, for example, in response to changes in the personal domain, at periodic intervals determined by the requesting device, or in response to a query from a content provider. If the requesting device is configured to update the database in response to changes in the personal domain and there have been no changes in the personal domain since the last query from the content provider, this may be quickly determined and indicated to the content provider.

At step 108, the requesting device compiles the information characterizing the personal domain and sends it to the DRM system using a secure method, such as by including it in an encrypted message over a network. The network may comprise, for example, an open communications network such as the Internet, or a cable or satellite network. In the alternative, the personal domain information may be provided over a private communication line, such as a dial-up telephone line or satellite link.

At step 110, a central controller within the DRM system uses the information from the parameter assessment tools to determine a threat index for the requesting device. The threat index may be based on a weighted combination of the control parameters in a risk assessment algorithm. The algorithm may be fixed by the DRM controller, or may vary as a function of the type of content requested or other factors. In addition, or in the alternative, a calculated threat index may be compared with a risk threshold set by the DRM controller. The risk threshold may likewise be fixed or variable.

There will usually exist varying degrees of confidence regarding the characteristics of a domain, such, as regarding the identity of the content users, locations of the receiving device, and the number of additional receiving devices in a personal domain. Calculation of the threat index or the magnitude of a comparative risk threshold may depend on the certainty regarding the personal domain information. For example, if there is a high degree of certainty concerning who is actually using the protected content, then other factors, such as the number or location of devices in the personal domain, may be given less weight. Conversely, if there is only a low degree of certainty about who is actually using the protected content, then a higher weight may be assigned to these other factors. In other words, the relative weight of personal domain factors may vary in inverse proportion to a degree of certainty. The degree of certainty associated with a factor, in turn, may be determined from various factors, for example, the method used to gather the information, the quality of an information response, degree of security associated with a transmission, past history of the user or personal domain, and so forth. Thus, using a weighted combination of various different information factors, a reasonably reliable profile of a personal domain or particular requesting device in the domain may be developed for use in a copy-protection scheme.

At step 112, a DRM engine or other suitable controller uses the threat index and any risk-tolerance thresholds associated with particular content to define rules governing use of the requested piece of content by a particular personal domain or a particular receiving device in the domain. The content usage rules may be supplied by the content provider for the particular requested content, for example, for pay-per-view content. In the alternative, usage rules may be more generally applicable, for example, based on the type of content requested, such as free-to-air TV, or the requesting user's subscription rights. Various content usage rules are known in the art of digital rights management, and may comprise, for example, copy control information (including number of allowed copies if copy one generation control), user/customer rights, location rights, real-time transmission display rights, playback display rights and other defined rights and limitations.

Thus, the content may be provided to the requesting device subject to usage rules specific to the requesting device or to its personal domain. For example, whether or not content may be viewed on a particular device may be determined by a set of different conditions, for example:
Right to View content on particular Display Device=True:
   If[(Threshold1 for User ID is met) OR
   ((Threshold2 for (Location ID=Local) is met) AND (Threshold3 for (Area is included in Allowed Areas) is met) OR
   ((Threshold4 for UserID) AND ((Threshold5 for (Location ID=Local is met) AND (Threshold6 for (Area is included in Allowed Areas) is met) AND (Device Count<10) AND (Device not a member of more than 2 other Personal Domains in past year))].

In the foregoing example, viewing of the content is permitted if any one of the alternate conditions separated by an “OR” clause is satisfied. “Threshold1” may be selected to require a very high degree of certainty as to the identity of the user. Thus, if it is certain or nearly certain that the content will be used only by an authorized user, then in this simple example, the status of other conditions is disregarded. Likewise, “Threshold2” and “Threshold3” may be selected so as to require a high degree of certainty that the receiving device meets the criteria for a “Local” device and is located in an “Allowed Area,” as alternate conditions permitting use of the content. In the third condition, the fourth through sixth threshold values may be selected to require less certainty than the first through third threshold values, respectively, subject to satisfaction of additional conditions concerning the number of devices in the domain and history of the device using the content.

The foregoing example is merely illustrative, and should not be construed as limiting the invention to use of a particular usage rule. One of ordinary skill may devise a great many different algorithms that operate according to the principles exemplified above. In addition, the usage rules may be further adapted to specify varying levels of usage for different devices within the requesting device's personal domain.

At step 114, the DRM system binds the usage rules to the requested content with any suitable type of cryptographic binding. The binding may be to a single element of the architectural elements of the content protection system, such as to a user, a geographic location, a personal domain, any device in the domain, or to media in which the content is encoded. For example, encrypted usage rules may specify that the content may be used anywhere in a specified personal domain; this would comprise an example of binding to a personal domain. In the alternative, or in addition, the content may be bound be to multiple elements, for example, to a user and a user's car, a user's home and set-top box, or any other desired combination. Optionally, content may be bound to multiple elements in a hierarchical manner. For example, content may be restricted to set-top boxes within a particular personal domain.

At step 116, the DRM system sends the bound content to the requesting device for use according to the embedded usage rules. The content should be encrypted so as to be unusable by a receiving device that is not compliant with the copy-protection system used by the content provider. Compliant devices that receive the bound content will likewise make use of it only if permitted by the bound usage rules. For example, the usage rules may specify that the content may only be used by a device that is directly connected to a particular set-top box of a personal domain. If the personal domain comprises another compliant set-top box, or compliant devices that are indirectly connected (e.g., using a wide-area network) to the permitted set-top box, these devices will not play the bound content. Likewise, non-compliant devices connected to the network will not be able to decrypt the bound content.

FIG. 2 is a block diagram showing an embodiment of a system 200 for providing content protection and copy management for digital content within a personal domain 201 comprising a plurality of connected receiving devices. This block diagram depicts an example system that uses a rights management engine and centralized controller system included in the provider's source device. System 200 comprises at least one source device 204 with a digital rights management system 202 connected via a network 210 to one or more devices 206, 226 and 228 (e.g., a set-top box or player running on a personal computer or other devices) within a user's personal domain 201. In one embodiment, the network is a cable network. Network 210 may comprise any suitable network or networks for transmitting digital information, for example, the Internet, a digital satellite TV link, or other wired or wireless networks. Within the personal domain, receiving and playback devices may be connected via an in-home or local area network, a wide-area network such as the Internet, wired or wireless connections of all types, or any combination of the foregoing.

Receiving device 206 may be configured to request digital content 208 from the source device 204 over the network 210. Source device 204 may comprise, for example, a source of digital content operated by a cable or satellite TV service or other subscription content service, a source for a pay-per-view or pay-per-copy content, a free content source, or any combination of the foregoing.

The Digital Rights Management system 202 may be configured to send a query message to the receiving device 206 in response to a request for digital content. This query message may request that the receiving device assess a plurality of independent parameters for its domain. As previously described, parameters may include, but are not limited to, user identity, geographic location of the receiving device for the personal domain, location of all other receiving devices within the personal domain, count of receiving devices within the domain and history of domain membership. The receiving device 206 may be configured to use various parameter assessment tools, e.g., a location determination tool 212, a proximity determination tool 214, a user identification tool 216 and a consuming device counting tool 218, to gather the requested information.

Parameter assessment tools may be located inside or outside of domain 201, and may comprise any suitable system for assessing the relevant parameters. Such tool may be implemented using any suitable hardware, software, firmware, or combination of the foregoing. Tools may be integrated into receiving or playing devices in the personal domain, as stand-alone devices inside or outside the personal domain, or any combination of the foregoing. For example, location tool 212 may use ANI technology to determine a geographic area of the personal domain within an area code, as known in the art. In the alternative, or in addition, another location tool 214 may use a GPS system and local GPS receiver to determine a more precise location of the personal domain, in cooperation with remote GPS satellites and in communication with receiving device 206. Device counter 218 and user identification tool 216 may also respond with relevant information. Tools 212, 214, 216, and 218 are intended to be exemplary, and not limiting. Each potential receiving device may use any or all of the different types of tools to establish the necessary information to determine its authorized usage, i.e., receiving device 228 could have been connected to device count tool 218 and user ID tool 216 in addition to the two location tools 212 and 214. It may be desirable to integrate parameter assessment tools into receiving devices in the personal domain so as to operate automatically without inconveniencing content consumers. Any other desired information may also be collected using a suitable tool accessible to devices in domain 201.

One or more devices in the domain, such as receiving device 206, may be configured to collect or send information from the parameter assessment tools to a central controller system 220, or other operable controller within the DRM system. Information may be transmitted over network 210 using any suitable secure method, for example, encryption over an open network such as the Internet, or using a secure channel or private telephone line. The central controller 220 may be configured to use the information from the parameter assessment tools 212-218 to generate a threat index for the requesting device or for devices within its personal domain 201.

Alternatively, for the example system in which the rights management system and decentralized controller system are embodied within one or more devices in the personal domain, one or more devices in the domain may collect the information and perform the secure method to determine authorized usage autonomously from the original source device. In this alternative case, the source device will have transmitted the original content with signaled usage rights that it then trusts the secure rights management system and decentralized controller system in the personal domain to enforce. Different levels of shared control between the centralized and decentralized versions will be obvious to those skilled in the art. For example, a centralized process might be used periodically, e.g., every week or month, to update and assist an otherwise decentralized process.

The threat index, as previously described, may incorporate a weighted combination of the parameters for which information was supplied. The relative weights of each parameter may vary according to the particular tools used and their level of precision. In addition, or in the alternative, risk tolerance thresholds for each parameter, or for any combination of parameters, may be set depending on the particular content requested or other criteria.

The central controller 220 or other component of DRM 202 may also be configured to provide the threat index and the specific control parameter information to a rights management engine 222. The rights management engine 222 may be configured to use this information and defined usage criteria for the requested content to determine specific usage rules for use of the requested content by devices in the personal domain. For example, an algorithm may be employed by the DRM to calculate a threat index, and compare the index to allowable risk thresholds for the personal domain or for particular devices in the domain, to select desired rules applicable to specific content, devices, or domains. Illustrative examples are provided elsewhere in the specification, in view of which one of ordinary skill should be able to construct various suitable algorithms for different situations. In general, such algorithms should not rely on a single risk assessment criteria, but should employ a combination of measured parameters for the personal domain, so as to enhance the robustness and reliability of content control without unduly inconveniencing consumers.

A content usage right as determined by the source device 204 for each piece of content may be stored within a secure, authenticated database 224 on the digital rights management system. Such rights may be applied to other content for a specified domain, if desired. For example, the same rules may be applied to content of matching types for a particular domain or device. Likewise, the same rules may be applied for use in domains having identical or similar risk profiles. The digital rights management system 202 may also be configured to bind specific usage rules for content to any suitable element of the content protection and copy management system. For example, usage rules may be bound to elements such as a user identification code, a geographic location, a receiving/playback device, storage media such as an optical disc, or embedded in a transmission of content. After suitably binding the usage rule, DRM system 202 may be configured to transmit the content to the receiving device 206 over the network 210.

Having thus described a preferred embodiment of a method and system for controlling distribution of digital content using multiple independent parameters of a receiving domain, it should be apparent to those skilled in the art that certain advantages of the within system have been achieved. It should also be appreciated that various modifications, adaptations, and alternative embodiments thereof may be made within the scope and spirit of the present invention. For example, a system with certain control parameters has been illustrated, but it should be apparent that the inventive concepts described above would be equally applicable for any number of logical and weighted combinations of control parameters relating to time, space, count, relationships between connected or networked devices, usage history, and other parameters. In addition, the invention is not limited to a particular type of digital content, and may be used in the distribution of content to various types of receiving devices, including televisions, music players, general-purpose computing devices, communication devices such as mobile telephones, personal digital assistants and other similar devices. The invention is defined by the following claims.

1. A method for controlling distribution of digital content within a personal domain that includes multiple receiving devices, the method comprising:
assessing a plurality of independent parameters for a personal domain;
determining a threat index based on the plurality of independent parameters;
determining usage rules for content to be delivered to the personal domain based on the threat index and a secure, authenticated usage right for the content; and
providing the usage rules to a receiving device in the personal domain, the usage rules operative to control use of the content by the receiving device.

2. The method of claim 1, wherein the first determining step further comprises determining the threat index using a weighted combination of the independent parameters.

3. The method of claim 1, wherein the assessing step further comprises selecting the independent parameters to include at least three of a user identity, location of a receiving portal for the personal domain, locations of receiving devices within the personal domain, and a count of receiving devices in the personal domain.

4. The method of claim 1, wherein the assessing step further comprises developing an assessment for each of the parameters using an assessment tool operating in the personal domain.

5. The method of claim 4, further comprising transmitting the assessment for each of the parameters to a decentralized controller located within one or more devices within the personal domain.

6. The method of claim 4, further comprising transmitting the assessment for each of the parameters to a central controller located outside of the personal domain.

7. The method of claim 6, wherein the transmitting step further comprises using a secure method for the transmitting of the parameters.

8. The method of claim 1, wherein the second determining step further comprises determining the usage rules comprising at least one rule selected from the following categories: (1) whether or to what extent copying of the content is allowed, (2) a number of different users to whom the content may be redistributed, (3) a number of different locations to which the content may be distributed, (4) a number of allowed concurrent real-time displays, or (5) a number of concurrent displays of stored content.

9. The method of claim 1, wherein the second determining step further comprises determining the usage rules for application to all devices in the personal domain.

10. The method of claim 1, wherein the second determining step further comprises determining the usage rules to comprise different rules intended for different devices in the personal domain.

11. The method of claim 1, wherein the second determining step further comprises determining the usage rules to permit a plurality of devices in the personal domain to receive the content.

12. A system for gathering information about a requesting device's personal domain, comprising:
a controller operably associated with a plurality of assessment tools, the controller configured to collect independent domain parameters from the plurality of assessment tools, wherein the independent domain parameters pertain to a personal domain for receiving usage-controlled content; and
a memory operably associated with the controller, the memory holding program instructions for providing the independent domain parameters for use in determining content usage rules for the usage-controlled content.

13. The system of claim 12, wherein the program instructions further comprise instructions for encrypting the independent domain parameters prior to transmission to a digital rights management system.

14. The system of claim 12, wherein the plurality of assessment tools comprise tools configured to determine at least two of a user identity, location of a receiving portal for the personal domain, locations of receiving devices within the personal domain, a geographic location for at least one device in the personal domain, relative proximity of at least two devices in the personal domain, prior domain membership of at least one device in the personal domain, prior content received by at least one device in the personal domain, and a count of receiving devices in the personal domain.

15. The system of claim 12, wherein the plurality of assessment tools comprise at least one tool configured to determine a geographic location for a receiving device using automatic number identification.

16. The system of claim 12, wherein the plurality of assessment tools comprise at least one tool configured to determine a geographic location for a receiving device using a GPS receiver.

17. A system for controlling the distribution of digital content within a personal domain, comprising:
a controller configured to receive control parameter information from a requesting device about the requesting device's personal domain; and
a memory operably associated with the controller, the memory holding program instructions for (a) generating a threat index based on the control parameter information received from the requesting device, (b) comparing the threat index and a usage right for the requesting device, (c) determining usage rules for requested content, based on the comparison of the threat index and a risk-tolerance threshold for the requested content, and (d) providing the usage rules to a receiving device in the personal domain, the usage rules operative to control use of the content by the receiving device.

18. The system of claim 17, wherein the program instructions further comprise instructions for generating the threat index based on a weighted combination of the control parameter information received from the requesting device.

19. The system of claim 18, wherein the program instructions further comprise instructions for maintaining the weighted combination of the control parameters fixed for all content.

20. The system of claim 18, wherein the program instructions further comprise instructions for varying the weighted combination of the control parameters depending on a type of requested content.

21. The system of claim 17, wherein the program instructions further comprise instructions for determining the risk-tolerance threshold from criteria associated with content.

22. The system of claim 17, wherein the program instructions further comprise instructions for varying the risk-tolerance threshold depending on a type of requested content.

23. The system of claim 17, wherein the program instructions further comprise instructions for determining the usage rules differently for different receiving devices within a personal domain of the requesting device.
